(19) United States
(12) Patent Application Publication
(10) Pub. No.: US 2023/0289994 A1
(43) Pub. Date: Sep. 14, 2023

(54) OBJECT POSITION DETECTION APPARATUS

(71) Applicant: Mitsubishi Electric Corporation, Tokyo (JP)

(72) Inventors: Genki TANAKA, Tokyo (JP); Takuya Taniguchi, Tokyo (JP)

(73) Assignee: Mitsubishi Electric Corporation, Tokyo (JP)

(21) Appl. No.: 18/095,231

(22) Filed: Jan. 10, 2023

(30) Foreign Application Priority Data
Mar. 9, 2022 (JP) 2022-035918

(51) Int. Cl. G06T 7/70; G06T 7/62; G06V 10/74

(52) U.S. Cl. CPC G06T 7/70; G06T 7/62; G06V 10/761; G06T 2207/20132

(57) ABSTRACT

To provide an object position detection apparatus which can calculate a position of object in the real world with good accuracy from the image imaged by the roadside monitoring camera, while suppressing erroneous detection, even for geographical feature where height of floor changes variously. An object position detection apparatus acquires the coordinate transformation equation of the image area corresponding to the position in image of the object, from the map data; and transforms the position in image of the object into the position of the real world coordinates the coordinate transformation equation; acquires information on size limitation and information on existence possibility and the object type from the map data; determines a presence or absence of erroneous detection of the object; and distributes outside a position of real world coordinates of the object with no erroneous detection.

### INCORPORATION BY REFERENCE

The disclosure of Japanese Patent Application No. 2022-35918 filed on Mar. 9, 2022 including its specification, claims and drawings, is incorporated herein by reference in its entirety.

### BACKGROUND

This present disclosure relates to an object position detection apparatus.

For implementation of automatic driving in a specific area, it is studied that the roadside machine which detects the object in the area and distributes object information to a vehicle, a person, a dynamic map, and the like is installed on the road. A sensor, such as camera and LiDAR, is mounted in the roadside machine; the object is detected by performing various processing to detection information of the sensor; and position information in the real world of the detected object is calculated and distributed.

Herein, in order to calculate a position of the detected object from the image imaged by the camera, it is necessary to perform the calibration of the camera and to calculate calibration parameters, such as a position and a direction of the camera, by a five-point algorithm and the like.

For example, in JP 2021-117087 A, a plurality of sensors are simply calibrated by calculating relative positions and postures between the plurality of sensors; and the calculation accuracy of the object position is improved by correcting height information of floor using distance information obtained by the sensor, such as LiDAR.

### SUMMARY

However, even if calibration is correctly performed by the above method, erroneous detection of the object in the image processing (the object not existing is detected), and undetection of object (the existing object cannot be detected) cannot be prevented completely, and the object information which is erroneously detected with a certain probability is distributed.

For example, the object is erroneously detected in the image area where the object of detection target cannot exist; and the object of normally impossible size considering the distance from the camera is erroneously detected.

If only the monocular camera from which distance information is not obtained is used, a transformation from the object position in the image to the position in the real world is performed, usually assuming the same plane. Accordingly, in geographical feature where height of floor changes variously, calculation accuracy of position is deteriorated.

Then, the purpose of the present disclosure is to provide an object position detection apparatus which can calculate a position of object in the real world with good accuracy from the image imaged by the roadside monitoring camera, while suppressing erroneous detection of object, even for geographical feature where height of floor changes variously.

An object position detection apparatus according to the present disclosure, including:
an image acquisition unit that acquires a image from a roadside monitoring camera which is installed on a roadside and monitors a road state;
an object detection unit that detects an object which is included in the image, and an object type;
a map storage unit that stored object information map data in which a coordinate transformation equation which transforms from a position in image into a position of real world coordinates, information on size limitation on image of the each object type, and information on existence possibility of object of the each object type were set for each divided image area;
an object position calculation unit that acquires the coordinate transformation equation of the image area corresponding to the position in image of the detected object, from the object information map data, and transforms the position in image of the detected object into the position of the real world coordinates using the acquired coordinate transformation equation;
an erroneous detection determination unit that acquires the information on size limitation and the information on existence possibility of object of the image area corresponding to the position in image of the detected object, and the detected object type, from the object information map data, and determines a presence or absence of erroneous detection of the object, based on the acquired information on size limitation, the acquired information on existence possibility, and a size on image of the detected object; and
a position output unit that distributes outside the position of real world coordinates and the object type of the object determined that there is no erroneous detection.

According to the object position detection apparatus of the present disclosure, the coordinate transformation equation of the image area corresponding to the position in image of the detected object is acquired from the object information map data; and the position in image of the detected object is transformed into the position of real world coordinates using the acquired coordinate transformation equation. Accordingly, even for geographical feature where height of floor changes variously in each image area, the position transformation can be performed with good accuracy, using the coordinate transformation equation corresponding to the height of floor of each image area. The information on size limitation and the information on existence possibility of object of the image area corresponding to the position in image of the detected object and the detected object type are acquired from the object information map data; and the presence or absence of the erroneous detection of the object is determined, based on the acquired information and the size on image of the detected object. Accordingly, since the information on existence possibility of object of each object type of each image area is used, it can be suppressed that the object is erroneously detected in the image area where there is no possibility of existence of object. And, since the information on size limitation of each object type of each image area is used, it can be suppressed that the object of normally impossible size considering the distance from the roadside monitoring camera to the object of each image area and the object type is erroneously detected. Accordingly, the position of object in the real world can be calculated with good accuracy from the image imaged by the roadside monitoring camera, while suppressing erroneous detection of object, even for geographical feature where height of floor changes variously.

### BRIEF DESCRIPTION OF THE DRAWINGS

FIG. 1 is a schematic configuration diagram of the object position detection apparatus according to Embodiment 1;

FIG. 2 is a schematic hardware configuration figure of the object position detection apparatus according to Embodiment 1;

FIG. 3 is a figure for explaining the floor range of the real world imaged by the roadside monitoring camera according to Embodiment 1;

FIG. 4 is a figure for explaining the image imaged by the roadside monitoring camera according to Embodiment 1;

FIG. 5 is a figure for explaining setting of the object information map data according to Embodiment 1;

FIG. 6 is a figure for explaining creation and setting of the coordinate transformation equation according to Embodiment 1;

FIG. 7 is a flowchart for explaining processing of the object position detection apparatus according to Embodiment 1;

FIG. 8 is a schematic configuration diagram of the object position detection apparatus according to Embodiment 2;

FIG. 9 is a figure for explaining the cutting-out of image according to Embodiment 2;

FIG. 10 is a flowchart for explaining processing of the object position detection apparatus according to Embodiment 2;

FIG. 11 is a schematic configuration diagram of the object position detection apparatus according to Embodiment 3; and

FIG. 12 is a flowchart for explaining processing of the object position detection apparatus according to Embodiment 3.

### DETAILED DESCRIPTION OF THE EMBODIMENTS

### 1. Embodiment 1

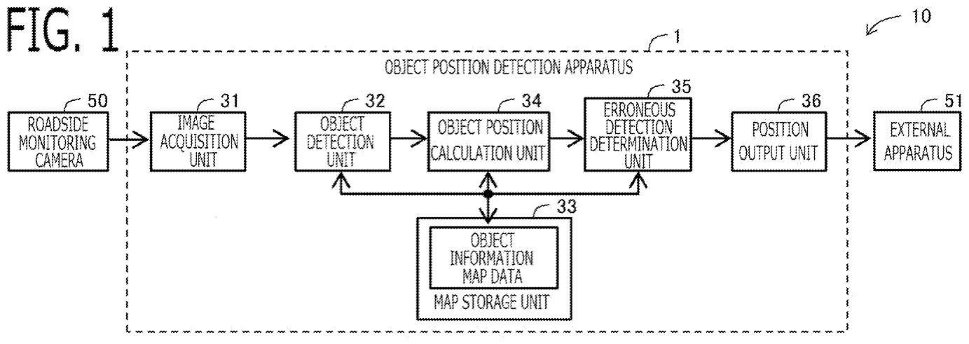

An object position detection apparatus 1 according to Embodiment 1 will be explained with reference to drawings. FIG. 1 shows a schematic configuration diagram of the object position detection apparatus 1 and an object position detection system 10.

The object position detection system 10 is provided with the object position detection apparatus 1 and a roadside monitoring camera 50. The roadside monitoring camera 50 is a monitoring camera which is installed on a roadside and monitors a road state. For example, the roadside monitoring camera 50 is provided in a roadside machine. An image data imaged by the roadside monitoring camera 50 is inputted into the object position detection apparatus 1. Between the roadside monitoring camera 50 and the object position detection apparatus 1 is connected by a wireless communication or a cable communication so as to communicate data.

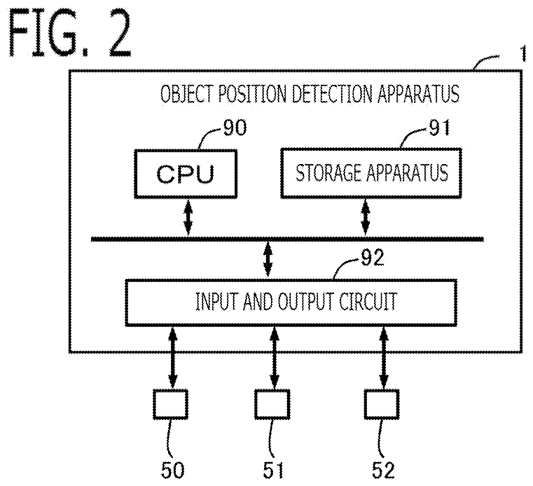

The object position detection apparatus 1 is provided with functional units of an image acquisition unit 31, an object detection unit 32, a map storage unit 33, an object position calculation unit 34, an erroneous detection determination unit 35, a position output unit 36, and the like. Each function of the object position detection apparatus 1 is realized by processing circuits provided in the object position detection apparatus 1. As shown in FIG. 2, specifically, the object position detection apparatus 1 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), various kinds of AI (Artificial Intelligence) chips, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the roadside monitoring camera 50, an external apparatus 51, a user interface apparatus 52, and the like, and communicates with these apparatuses.

Then, the arithmetic processor 90 runs software items (programs) stored in the storage apparatus 91 and collaborates with other hardware devices in the object position detection apparatus 1, such as the storage apparatus 91, and the input and output circuit 92, so that the respective functions of the functional units 31 to 36 included in the object position detection apparatus 1 are realized. Setting data utilized in the functional units 31 to 36 are stored in the storage apparatus 91, such as EEPROM. The map storage unit 33 is provided in the storage apparatus 91, such as EEPROM.

### <Roadside Monitoring Camera 50>

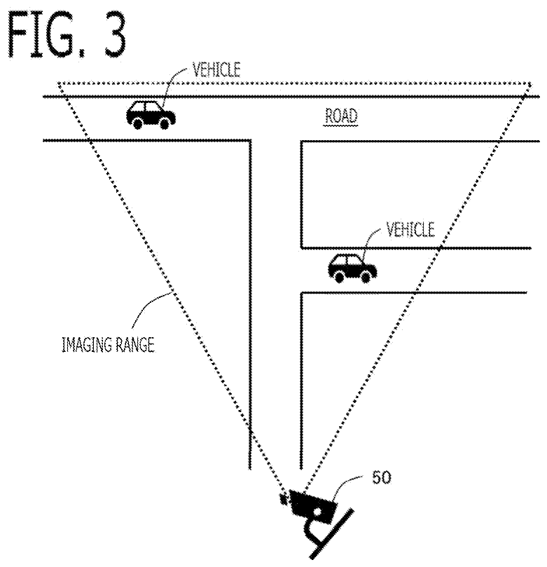

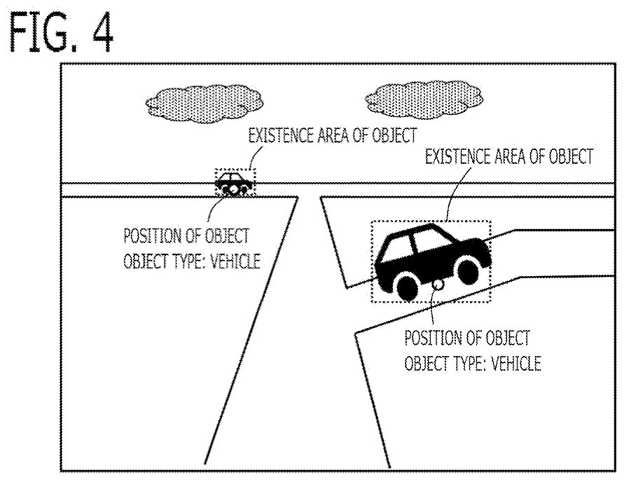

FIG. 3 shows an image figure when planarly viewing a floor range of the real world imaged by the roadside monitoring camera 50. FIG. 4 shows an image figure of an image imaged by the roadside monitoring camera 50 in the example of FIG. 3. The roadside monitoring camera 50 is installed at a certain height (for example, several meters) from the road surface, and direction of the camera is set so that a certain floor range can be imaged.

Herein, the floor is a surface which faces upward, such as a road surface, a ground surface, and a floor of building, and a surface on which an object, such as a vehicle, is located.

The roadside monitoring camera 50 images at several fps to 30 fps (frame per second), for example, and transmits the imaged image to the object position detection apparatus 1 (the image acquisition unit 31) using various kinds of communication means of cable communication or wireless communication. The roadside monitoring camera 50 is provided with a communication device integrally or separately.

### <Image Acquisition Unit 31>

The image acquisition unit 31 acquires an image from the roadside monitoring camera 50. The image acquisition unit 31 acquires an image from the roadside monitoring camera 50 via various kinds of communication means of cable communication or wireless communication. The object position detection apparatus 1 may not be arranged close to the roadside monitoring camera 50, be arranged in a distant place, and communicate with the roadside monitoring camera 50 via network.

### <Object Detection Unit 32>

The object detection unit 32 detects an object and an object type which are included in the image. For example, the object detection unit 32 performs well-known various kinds of image processing to the image, and detects the object and the object type. For example, as the image processing, well-known technology using pattern matching, neural network, and the like is used. When a plurality of objects are included in the image, the plurality of objects and those object type are detected, and processing described below is performed for each object.

In the present embodiment, an object type of detection target is set to the object type (for example, a vehicle, a person, and the like) which is required for operation of a road transportation system, such as an automatic driving of vehicle. The object detection unit 32 detects only the object of the object type of detection target included in the image. Detectable object types and detection accuracy depend on algorithm and model of image processing used in the object detection unit 32. If the detection accuracy is good, more detailed information, for example, vehicle kind, person kind, other object types, and the like, may be detected.

A resolution (size) and a range of an image which is inputted into an object detection algorithm (the object detection model) which uses pattern matching, neural network, and the like are generally fixed (for example, size of (height, width, channel number)=(608, 608, 3), and range of 0 to 1). Accordingly, the acquired image is inputted into the object detection model after performing pre-processing of reduction, standardization, and the like so as to suite the input of the object detection model.

The object detection unit 32 detects an area on image where the detected object exists (hereinafter, referred to as an existence area). For example, the existence area of the object is detected by a rectangular area, as shown in FIG. 4. The existence area of the object may be detected by an outline line of the object, may be detected by pixels, or may be detected by other method.

The object detection unit 32 sets an arbitrary representative position of the existence area of the object as the position in image of the object. For example, a center position of the existence area of the object, a center position of a lower end of the object corresponding to a position of the object on the floor, or the like is set as the position of the object.

### <Map Storage Unit 33>

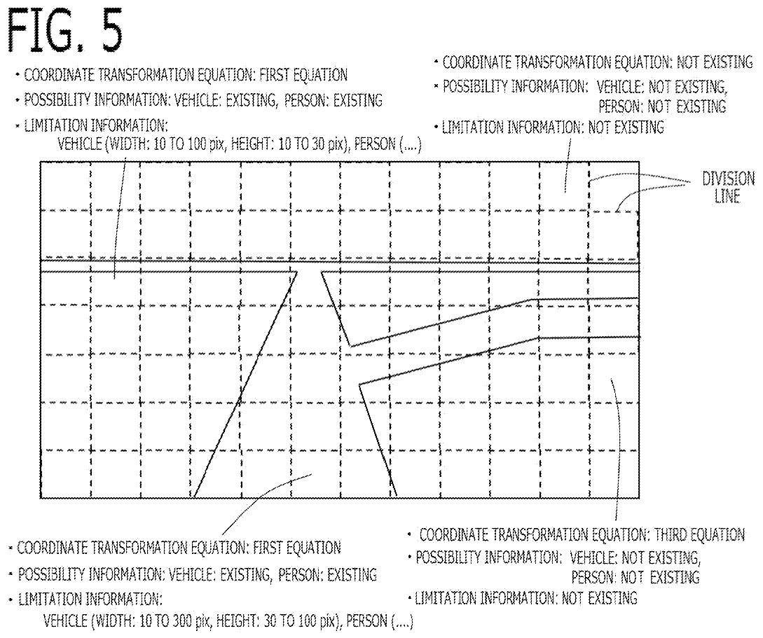

The map storage unit 33 stores an object information map data. The map storage unit 33 is provided in the storage apparatus 91. As shown in FIG. 5, in the object information map data, for each of image areas where a range of the image was divided into a plurality of areas, a coordinate transformation equation which transforms from a position in image to a position of real world coordinates, information on size limitation on image of the each object type, and information on existence possibility of object of each object type were set. FIG. 5 shows example of data setting about four image areas.

For example, as shown in FIG. 5, whole area of the image is divided in grid shape and a plurality of image areas are set. In the example of FIG. 5, although the image is divided equally, arbitrary dividing pattern of the image areas may be set. For example, the dividing interval of the division lines may be narrowed as it becomes far away. Alternatively, the division lines of the image areas may be set in accordance with a shape of road, a shape of floor area on the same plane, or a type of floor. The image areas may be set in pixels.

The coordinate transformation equation set for each image area is a transformation equation which transforms from a position in image (for example, pixel position (x, y)) into a position of real world coordinates (latitude, longitude, height). For example, the coordinate transformation equation is a transformation equation which transforms positions on floor mutually.

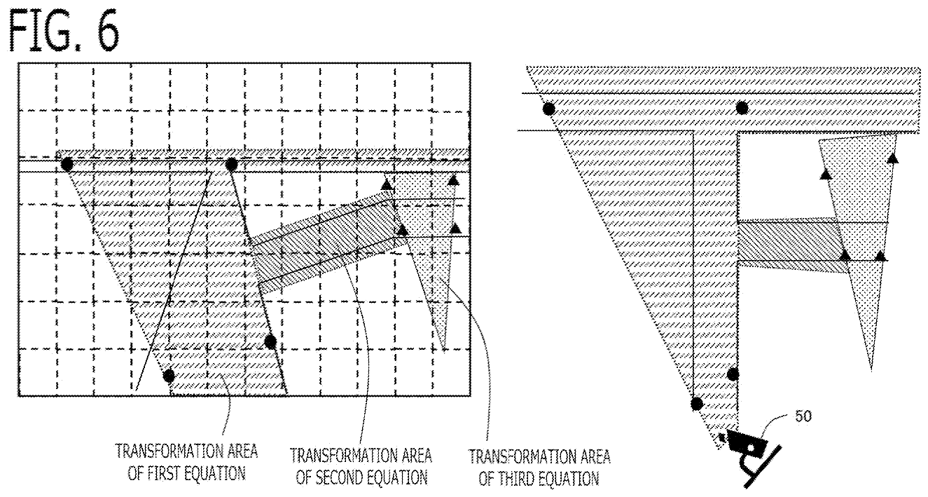

FIG. 6 is a figure for explaining creation and setting of the coordinate transformation equation. The coordinate transformation equation may be an equation which correlates between the pixel position in image and the position of real world coordinates one to one. For example, the coordinate transformation equation is created by the projective transformation between the positions of four points on image, and the corresponding positions of four points of the real world coordinates acquired by GPS. For example, the projective transformation between positions of four circles in the left figure of FIG. 6, and positions of four circles in the right figure, and the projective transformation between positions of four triangles in the left figure of FIG. 6, and positions of four triangles in the right figure.

The projective transformation transforms by assuming that the positions of four points are on the same plane. If there are a plurality of floor areas which become the same plane in the area of real world corresponding to the area of whole image, a plurality of coordinate transformation equations are created corresponding to each of the plurality of floor areas which become the same plane, and the coordinate transformation equation corresponding to a position of each image area is selected from the plurality of the coordinate transformation equations, and preliminarily set.

That is, the coordinate transformation equation of each image area is set to the same coordinate transformation equation between the image areas where floors are on the same plane in the real world coordinates, and is set to a different coordinate transformation equation between the image areas where floors are not on the same plane in the real world coordinates.

According to this configuration, even for geographical feature where height and inclination of floor change variously, position transformation can be performed with good accuracy. Since the coordinate transformation equation may be created for every floor on the same plane, the setting man hour of the coordinate transformation equation of each image area can be reduced.

The information on size limitation on image of each object type is set for each image area of the object information map data. In the present embodiment, the object type is an object type which is required for a road transportation system of the automatic driving of vehicle and the like. For example, a vehicle and a person are used. If the object detection accuracy of the object detection unit 32 is good, more detailed information, for example, vehicle kind, person kind, other object types, and the like, may be used for setting of the information on size limitation.

The information on size limitation on image of each object type is information on an upper limit value and a lower limit value of size of the existence area of the object on image (width, height, pixel number, and the like). That is, a possible range of vehicle size and person size in the real world was decided to some extent (for example, the total length of vehicle is 1 meter to 3 meter, and the height of person is 50 centimeter to 2 meter), and the size on image becomes small as the distance from the roadside monitoring camera 50 becomes long (it is proportional to a reciprocal of the distance approximately). Then, in the information on size limitation of the each object type for the each image area, as the distance from the roadside monitoring camera to the object of the image area becomes long in the real world coordinates, the upper limit value and the lower limit value of size are preliminarily set so as to become small. As described later, it can be determined that the object which exceeds the limitation was detected erroneously.

The information on existence possibility of object for each object type is set for each image area of object information map data. The information on existence possibility of object is information on whether or not there is any possibility that the object of each object type exists in each image area. For example, in an area where objects other than floor, such as air and wall surface, are imaged, a possibility that the object on the floor exists is low. Accordingly, when the object type of detection target, such as the vehicle, is detected in this area, a possibility of erroneous detection is high. In an area where a floor on which the vehicle cannot travel is imaged, such as arable land, a possibility of existence of the vehicle is normally low. On the other hand, in an area where the road surface is imaged, a possibility of existence of the vehicle and the person is high. Then, the information on existence possibility of object of each object type for each image area is preliminarily set according to whether or not there is a floor where the object of each object type can be located in the real world coordinates, in the each image area. For each object type, it is preliminarily sets that there is a possibility of existence of object, when there is a floor where the object can be located in the real world coordinates, and it is preliminarily sets that there is no possibility of existence of object, when there is no floor where the object can be located in the real world coordinates.

It is desirable that the object information map data stored in the storage apparatus 91 can be rewritten from the outside. Accordingly, when the road shape is changed or the shape of structure, such as building and wall surface, is changed by construction and the like, the coordinate transformation equation, the information on size limitation, and the information on existence possibility of object of each image area can be changed, and the detection accuracy can be kept.

### <Object Position Calculation Unit 34>

The object position calculation unit 34 acquires the coordinate transformation equation of the image area corresponding to the position in image of the detected object, from the object information map data; and transforms the position in image of the detected object into the position of the real world coordinates using the acquired coordinate transformation equation. In the present embodiment, as mentioned above, the representative position of the existence area of the object in the image is set as the position in image of the object.

### <Erroneous Detection Determination Unit 35>

The determination unit acquires the information on size limitation and the information on existence possibility of object of the image area corresponding to the position in image of the detected object, and the detected object type, from the object information map data; and determines a presence or absence of erroneous detection of the object, based on the acquired information on size limitation and the acquired information on existence possibility, and a size on image of the detected object.

In the present embodiment, the erroneous detection determination unit 35 acquires the information on size limitation (an upper limit value and a lower limit value) of the image area corresponding to the detected position in image of the object and the detected object type, from the object information map data. Then, the erroneous detection determination unit 35 determines whether or not the size (area, pixel number) of the existence area of the object on the image is within a range of the limitation information (the upper limit value and the lower limit value); determine that there is no erroneous detection of the object about the limitation information, when it is within the range; and determine that there is erroneous detection of the object about the limitation information, when it is out of the range.

In the present embodiment, the erroneous detection determination unit 35 acquires the information on existence possibility of object corresponding to the detected position in image of the object and the detected object type, from the object information map data. Then, the erroneous detection determination unit 35 determines that there is no erroneous detection of the object about the possibility information, when the acquired information is information that there is a possibility of existence of the object; and determines that there is the erroneous detection of the object about the possibility information, when the acquired information is information that there is no possibility of existence of the object.

Then, the erroneous detection determination unit 35 finally determines that there is the erroneous detection, when it was determined that there is the erroneous detection of the object about one or both of the limitation information and the possibility information; and finally determines that there is no erroneous detection, when it was determined that there is no erroneous detection of the object about both of the limitation information and the possibility information.

### <Position Output Unit 36>

The position output unit 36 distributes outside the position of real world coordinates and the object type of the object which was determined that there is no erroneous detection.

The position output unit 36 distributes the information on the object determined that there is no erroneous detection, to the external apparatus 51, such as the automatic driving vehicle which exists close to the real world area imaged by the roadside monitoring camera 50, and the traffic control system, by wireless communication or cable communication.

The position output unit 36 may not distribute outside the information on the object determined that there is the erroneous detection, or may distribute outside the information on the object with information indicating that there is a possibility of erroneous detection.

### <Flowchart>

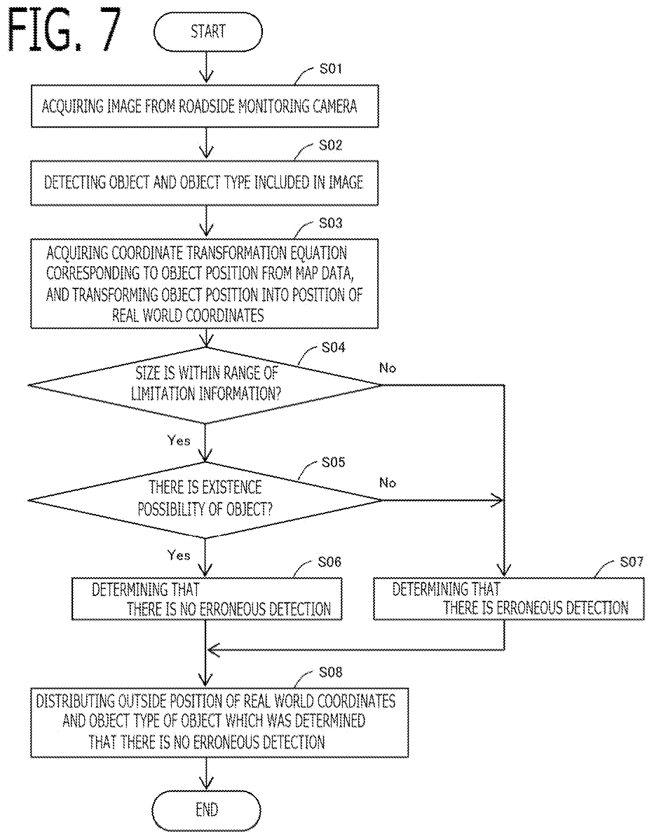

The processing of the object position detection apparatus 1 explained above can be configured as the flowchart of FIG. 7. For example, the processing of FIG. 7 is executed whenever the image data is acquired from the roadside monitoring camera 50.

In the step S01, as mentioned above, the image acquisition unit 31 acquires an image from the roadside monitoring camera 50. In the step S02, as mentioned above, the object detection unit 32 detects an object and an object type which are included in the image. In the step S03, as mentioned above, the object position calculation unit 34 acquires the coordinate transformation equation of the image area corresponding to the position in image of the detected object, from the object information map data stored in the map storage unit 33; and transforms the position in image of the detected object into the position of the real world coordinates using the acquired coordinate transformation equation.

Then, in the step S04, as mentioned above, the erroneous detection determination unit 35 acquires the information on size limitation of the image area corresponding to the detected position in image of the object and the detected object type, from the object information map data; determines whether or not the size of the existence area of the object on the image is within a range of the limitation information; advances to the step S05 when it is within the range; and advances to the step S07 when it is out of the range.

In the step S05, as mentioned above, the erroneous detection determination unit 35 acquires the information on existence possibility of object corresponding to the detected position in image of the object and the detected object type, from the object information map data; advances to the step S06 when the acquired information is information that there is a possibility of existence of the object; and advances to the step S07 when the acquired information is information that there is no possibility of existence of the object.

In the step S06, the erroneous detection determination unit 35 determines that there is no erroneous detection in the detected object. In the step S07, the erroneous detection determination unit 35 determines there is the erroneous detection in the detected object.

In the step S08, as mentioned above, the position output unit 36 distributes outside the position of real world coordinates and the object type of the object which was determined that there is no erroneous detection.

According to the above configuration, while suppressing the erroneous detection of the object, even for geographical feature where height and inclination of floor change variously, the position of the real world of the object can be calculated with good accuracy, and can be distributed outside.

### 2. Embodiment 2

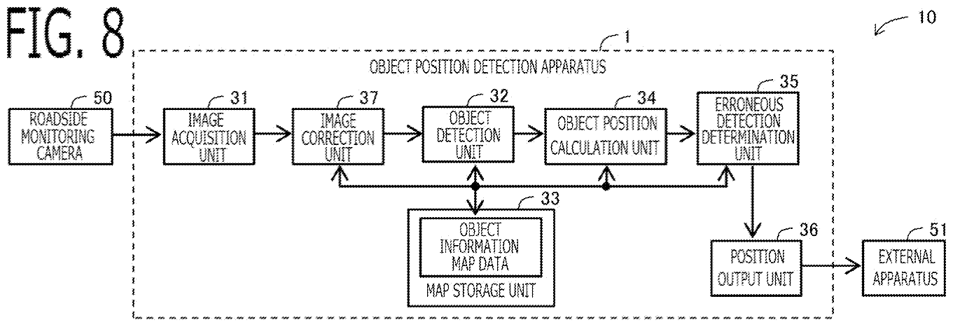

The object position detection apparatus 1 according to Embodiment 2 will be explained with reference to drawings. The explanation for constituent parts the same as those in Embodiment 1 will be omitted. The basic configuration of the object position detection apparatus 1 according to the present embodiment is the same as that of Embodiment 1. Embodiment 2 is different from Embodiment 1 in that an image correction unit 37 is provided. FIG. 8 shows a schematic configuration diagram of the object position detection apparatus 1 and the object position detection system 10.

In the present embodiment, the object position detection apparatus 1 is further provided with an image correction unit 37. The image correction unit 32 cuts out a partial area of the image acquired by the image acquisition unit 31. Then, the object detection unit 32 detects the object and the object type which are included in the cut out area of the image.

According to this configuration, since an area requiring processing is cut out from the acquired image and is processed, processing load can be reduced.

In the present embodiment, the image correction unit 37 acquires the information on existence possibility of object of the each image area from the object information map data; and sets a rectangular cut out area which covers the image areas which are set that there is a possibility of existence of object in the information on existence possibility of object, from the image. Then, the image correction unit 37 cuts out the rectangular cut out area from the image acquired by the image acquisition unit 31.

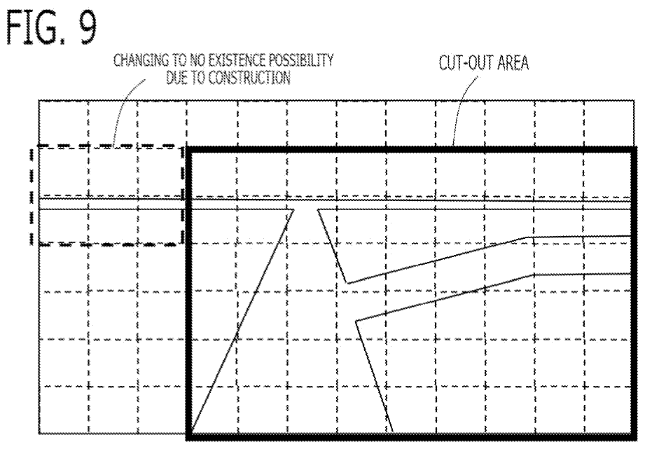

FIG. 9 shows an example of cutting-out of the image. The outside of an area enclosed by a thick frame line is an area which is set that there is no possibility of existence of the object. Accordingly, in the area outside the thick frame line, the object does not need to be detected, and the area inside the thick frame line may be cut out. As long as the image area which is set that there is a possibility of existence of the object is covered, the rectangular cut out area of any size may be set. However, for example, the rectangular cut out area of the minimum size which can cover the image area may be set. Since it is assumed that the object information map data is rewritten according to environmental status, such as construction, the cut out area may be changed whenever the object information map data is updated.

As described above, in the object detection model which uses the neural network or the like, generally, the input image size is fixed, processing such as reduction of inputted image is required. According to the configuration of the present embodiment, the image area inputted into the object detection model can be changed in accordance with the area required for detection, resolution deterioration by the image reduction can be suppressed as much as possible, and improvement in recognition performance of the object can be expected.

### <Flowchart>

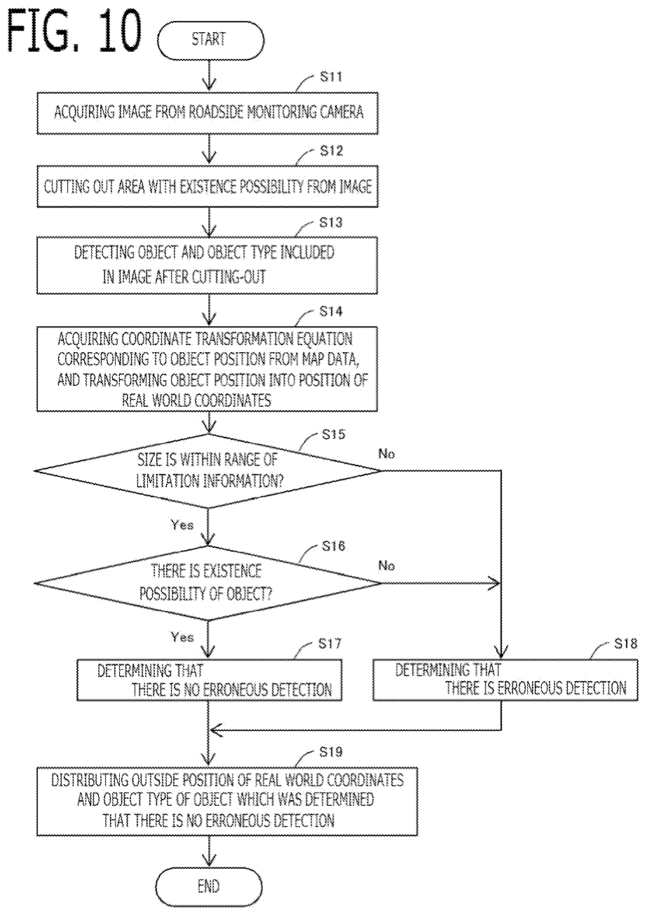

Processing of the object position detection apparatus 1 according to the present embodiment is explained using the flowchart of FIG. 10. Processing of step S12 is added to the flowchart of FIG. 7 of Embodiment 1. Since processings of steps S11 and S13 to S19 are the same as processings of steps S01 to S08 of FIG. 7, explanation is omitted.

In the step S12, as mentioned above, the image correction unit 37 acquires the information on existence possibility of object of the each image area from the object information map data; and sets a rectangular cut out area which covers the image areas which are set that there is a possibility of existence of object in the information on existence possibility of object, from the image. Then, the image correction unit 37 cuts out the rectangular cut out area from the image acquired by the image acquisition unit 31. Then, in the step S13, the object detection unit 32 detects the object and the object type which are included in the cut out image.

### 3. Embodiment 3

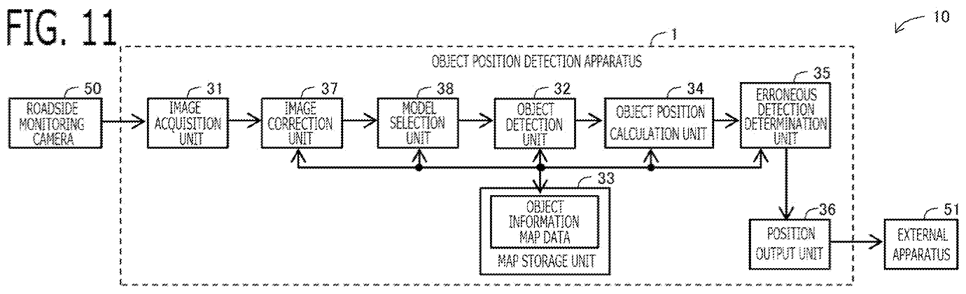

The object position detection apparatus 1 according to Embodiment 3 will be explained with reference to drawings. The explanation for constituent parts the same as that of Embodiment 1 or 2 will be omitted. The basic configuration of the object position detection apparatus 1 according to the present embodiment is the same as that of Embodiment 2. Embodiment 3 is different from Embodiment 2 in that a model selection unit 38 is provided. FIG. 11 shows a schematic configuration diagram of the object position detection apparatus 1 and the object position detection system 10.

The model selection unit 38 selects an object detection model used for detection of object in the object detection unit 32, according to a size of the image cut out by the image correction unit 37.

Generally, in the object detection model, as the inputted image size becomes large, an arithmetic amount becomes large, and it takes time to calculate. Generally, the input image size which can be inputted into the object detection model is fixed. When the image size outputted from the image correction unit 37 is smaller than the input image size specified in the object detection model, it is inputted into the object detection model after processing of expansion and the like is performed to the image. In this case, although the improvement in the detection performance of model cannot be expected, the arithmetic amount of processing increases, and excess calculation is performed.

Accordingly, when the image size cut out by the image correction unit 37 is smaller than the input image size specified in the object detection model used in the object detection unit 32, the model selection unit 38 switches to the object detection model in which the input image size less than or equal to the cut out image size is specified. Accordingly, the optimal model in arithmetic amount according to the image size can be used, suppression of calculation resource and power consumption required for calculation can be expected.

### <Flowchart>

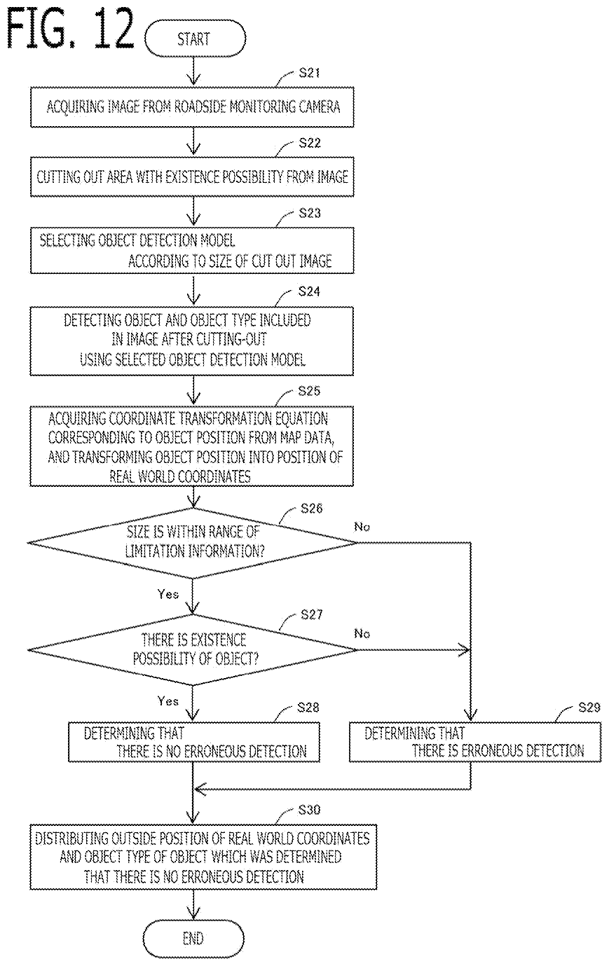

Processing of the object position detection apparatus 1 according to the present embodiment is explained using the flowchart of FIG. 12. Processing of step S23 is added to the flowchart of FIG. 12 of Embodiment 2. Since processings of steps S21 and S24 to S30 are the same as processings of steps S01 to S08 of FIG. 7, and processing of step S22 is the same as processing of step S12 of FIG. 10, explanation is omitted.

In the step S22, the image correction unit 37 acquires the information on existence possibility of object of the each image area from the object information map data; and sets a rectangular cut out area which covers the image areas which are set that there is a possibility of existence of object in the information on existence possibility of object, from the image. Then, the image correction unit 37 cuts out the rectangular cut out area from the image acquired by the image acquisition unit 31.

Then, in the step S23, the model selection unit 38 selects an object detection model used for detection of object in the object detection unit 32, according to a size of the image cut out by the image correction unit 37. Then, in the step S24, the object detection unit 32 detects the object and the object type which are included in the cut out image, using the object detection model selected by the model selection unit 38.

Although the present disclosure is described above in teams of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. An object position detection apparatus comprising at least one processor configured to implement:
an image acquisitor that acquires a image from a roadside monitoring camera which is installed on a roadside and monitors a road state;
an object detector that detects an object which is included in the image, and an object type;
a map storage that stored object information map data in which a coordinate transformation equation which transforms from a position in image into a position of real world coordinates, information on size limitation on image of the each object type, and information on existence possibility of object of the each object type were set for each divided image area;
an object position calculator that acquires the coordinate transformation equation of the image area corresponding to the position in image of the detected object, from the object information map data, and transforms the position in image of the detected object into the position of the real world coordinates using the acquired coordinate transformation equation;
an erroneous detection determiner that acquires the information on size limitation and the information on existence possibility of object of the image area corresponding to the position in image of the detected object, and the detected object type, from the object information map data, and determines a presence or absence of erroneous detection of the object, based on the acquired information on size limitation, the acquired information on existence possibility, and a size on image of the detected object; and
a position outputter that distributes outside the position of real world coordinates and the object type of the object determined that there is no erroneous detection.

2. The object position detection apparatus according to claim 1,
wherein in the information on size limitation of the each object type for the each image area, as a distance from the roadside monitoring camera to the object of the image area becomes long in the real world coordinates, an upper limit value and a lower limit value of size are preliminarily set so as to become small.

3. The object position detection apparatus according to claim 1,
wherein the information on existence possibility of the each object type for the each image area is preliminarily sets according to whether or not there is a floor where the object of the each object type can be located, in the image area in the real world coordinates.

4. The object position detection apparatus according to claim 1,
wherein the coordinate transformation equation for the each image area is preliminarily set to the same coordinate transformation equation, between the image areas where floors are on the same plane in the real world coordinates, and
the coordinate transformation equation for the each image area is preliminarily set to a different coordinate transformation equation, between the image areas where floors are not on the same plane in the real world coordinates.

5. The object position detection apparatus according to claim 1,
wherein the object detector detects an object of an object type of detection target, included in the image, and
wherein the object type of detection target is preliminarily set to an object type which is required for operation of a road transportation system.

6. The object position detection apparatus according to claim 1, further comprising
an image corrector which cuts out a partial area of the image acquired by the image acquisitor,
wherein the object detector detects the object and the object type which are included in the cut out area.

7. The object position detection apparatus according to claim 6,
wherein the image corrector acquires the information on existence possibility of object of the each image area from the object information map data, and
cuts out a rectangular area which covers the image areas which are set that there is a possibility of existence of object in the information on existence possibility of object, from the image.

8. The object position detection apparatus according to claim 6, further comprising
a model selector that selects an object detection model used for detection of object in the object detector, according to a size of the cut out image.
